(19) United States
(12) Patent Application Publication
(10) Pub. No.: US 2026/0236915 A1
(43) Pub. Date: Aug. 13, 2026

(54) METHODS PERFORMED BY A COMPUTING DEVICE

(71) Applicant: NCHAIN LICENSING AG, Zug (CH)

(72) Inventor: Owen VAUGHAN, London (GB)

(21) Appl. No.: 19/469,787

(22) PCT Filed: Feb. 29, 2024
(86) PCT No.: PCT/EP2024/055201

§ 371 Date: Sep. 26, 2025

(30) Foreign Application Priority Data
Mar. 28, 2023 (GB) 2304523.0

(51) Int. Cl. G06Q 20/38

(52) U.S. Cl. CPC G06Q 20/389; G06Q 20/38215

(57) ABSTRACT

A method performed by a computing device, the method comprising: transmitting a data distribution control message to a node of a blockchain network, the data distribution control message indicating that data in a transaction of a plurality of transactions, stored by the node and associated with a blockchain, should not be distributed by the node; receiving, from the node, a zero knowledge proof proving removal of the data from the transaction in compliance with the data distribution control message; generating a recordal transaction, the recordal transaction comprising evidence of removal of the data from the transaction in compliance with the data distribution control message; and transmitting the recordal transaction to the node for committal to the blockchain.

### CROSS REFERENCE TO RELATED APPLICATIONS

This application is the U.S. National Stage of International Application No. PCT/EP2024/055201 filed on Feb. 29, 2024, which claims the benefit of United Kingdom Patent Application No. 2304523.0 filed on Mar. 28, 2023, the contents of which are all incorporated herein by reference in their entireties.

### TECHNICAL FIELD

The present disclosure relates to methods performed by a computing device.

### BACKGROUND

Blockchains are designed to be immutable, meaning that data cannot be altered if it is embedded in the blockchain. This property makes removing unwanted data very difficult. If any data is removed from a blockchain transaction, then the remaining transaction data can no longer be validated. This is because one cannot reproduce the transaction ID by taking the double hash of the serialised transaction data since some data is missing. Subsequently, one cannot use a merkle proof to prove that the transaction was in a block, and then use proof of work (PoW) to prove that the block header was in the blockchain. This poses a challenge for node operators or other types of blockchain service providers who may need to distribute unwanted data as part of maintaining the blockchain given that the unwanted data could be illegal.

### SUMMARY

According to one aspect disclosed herein, there is provided a method performed by a computing device, the method comprising: transmitting a data distribution control message to a node of a blockchain network, the data distribution control message indicating that data in a spendable output of a transaction of a plurality of transactions, stored by the node and associated with a blockchain, should not be distributed by the node; receiving, from the node, a zero knowledge proof proving removal of the data from the transaction in compliance with the data distribution control message; generating a recordal transaction, the recordal transaction comprising evidence of removal of the data from the transaction in compliance with the data distribution control message; and transmitting the recordal transaction to the node for committal to the blockchain.

According to another aspect disclosed herein, there is provided a computer-readable medium storing processor-executable instructions, the processor-executable instructions including instructions that, when executed by one or more processors, cause the one or more processors to carry out any of the methods described herein. The computer-readable medium may be a non-transitory medium.

According to another aspect disclosed herein, there is provided a computer program comprising instructions which, when the program is executed by a computing device, cause the computing device to carry out any of the methods described herein.

The instructions may be provided on one or more carriers. For example there may be one or more non-transient memories, e.g. a EEPROM (e.g. a flash memory) a disk, CD-or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect disclosed herein, there is provided a computing device, the computing device including: one or more processors; memory; and computer-executable instructions stored in the memory that, when executed by the one or more processors, cause the processors to carry any of the methods described herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is an example transaction comprising unwanted data in a spendable output of the transaction,

FIG. 6 is an example transaction comprising unwanted data in an unspendable output of the transaction,

FIG. 7a is a schematic block diagram of a blockchain node,

FIG. 7b is a schematic block diagram of a data distribution control device,

FIG. 8 is a sequence diagram illustrating steps performed in accordance with embodiments of the present disclosure, and

FIG. 9 illustrates a transaction comprising unwanted data in a spendable output of the transaction, and two example recordal transactions.

### DETAILED DESCRIPTION OF EMBODIMENTS

### 1. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction. In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

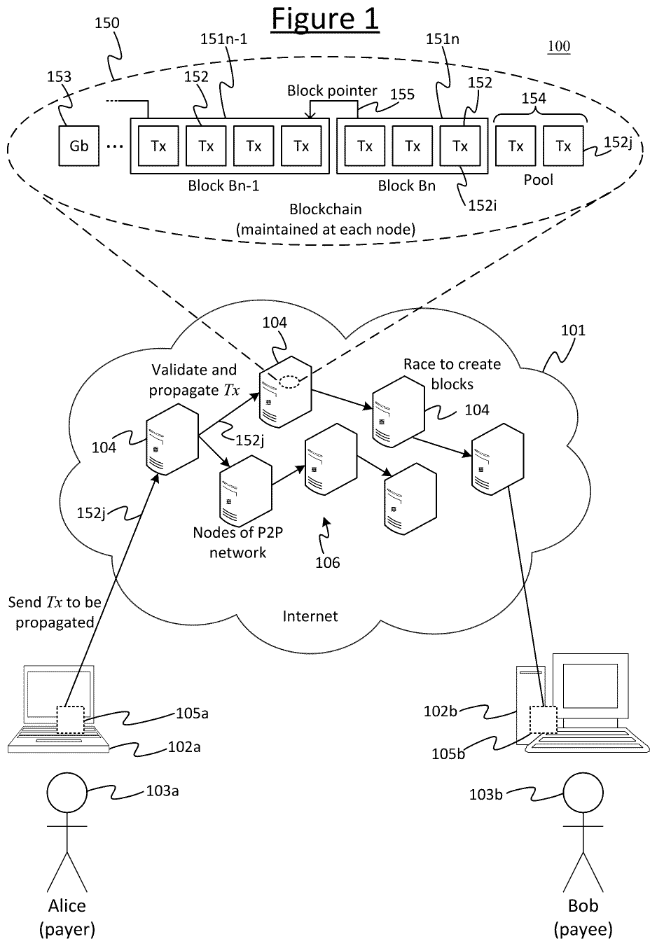

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 2. UTXO-Based Model

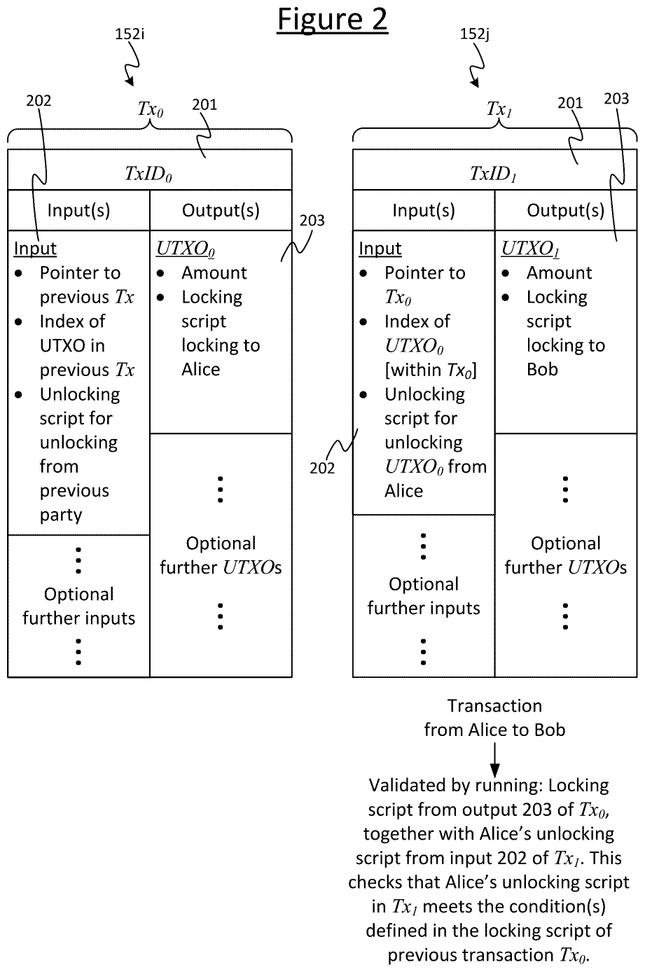

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig PA of Alice in order for UTXO₀ to be redeemed (strictly, in order for a subsequent transaction attempting to redeem UTXO, to be valid). [Checksig P_{A}] contains a representation (i.e. a hash) of the public key PA from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx1 further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP _... ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Client Software

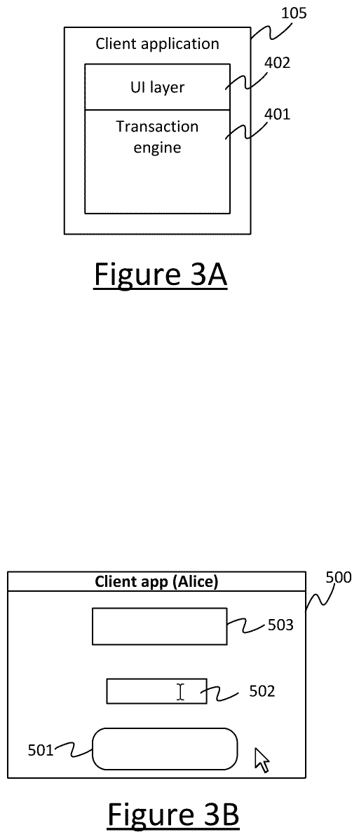

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The Ul layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to formulate transactions 152 and send transactions to one or more nodes 104 to be propagated through the blockchain network 106.

Alternatively or additionally, the UI elements may comprise one or more data entry fields 502, through which the user can ... These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 4. Node Software

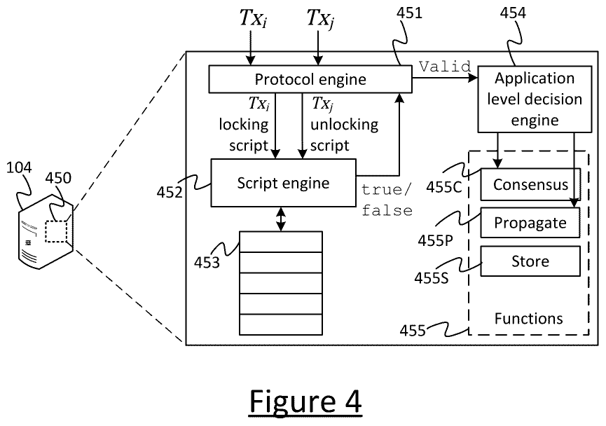

FIG. 4 illustrates an example of the node software 450 that is run on each blockchain node 104 of the network 106, in the example of a UTXO-or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains one or more of: a consensus module 455C (for example, proof-of-work), a propagation module 455P and a storage module 455S (for example, a database). The consensus module 455C may contain a validation module (not shown) configured to validate transactions according to the blockchain protocol. The validation module may instead be separate from the consensus module 455C. One or more of the modules may operate in parallel. A node 104 may contain additional modules. The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txᵢ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 5. Removal of Unwanted Data

As explained above, a respective copy of the blockchain 150 is maintained at each of a plurality of blockchain nodes 104 in the blockchain network 106 whereby each block 151 in the chain comprises one or more transactions 152.

In accordance with embodiments described herein, a blockchain node 104 receives a data distribution control message indicating that unwanted data of a transaction stored by the blockchain node 104 should not be distributed by the blockchain node 104. We refer herein to “unwanted data” as being any transaction data that is identified in a data distribution control message transmitted by a data distribution control device to the blockchain node 104. The unwanted data may for example be text data or image data. The unwanted data could be illegal, e.g. child pornography or the instructions to make a bomb, or it could violate a copyright.

A transaction can contain unwanted data in two different types of position within a transaction.

In one example, the unwanted data can be present in a spendable output of a transaction i.e. an unspent transaction output (UTXO). In particular, the unwanted data can be present in a locking script of the transaction only, and not in any metadata fields such as bitcoin value.

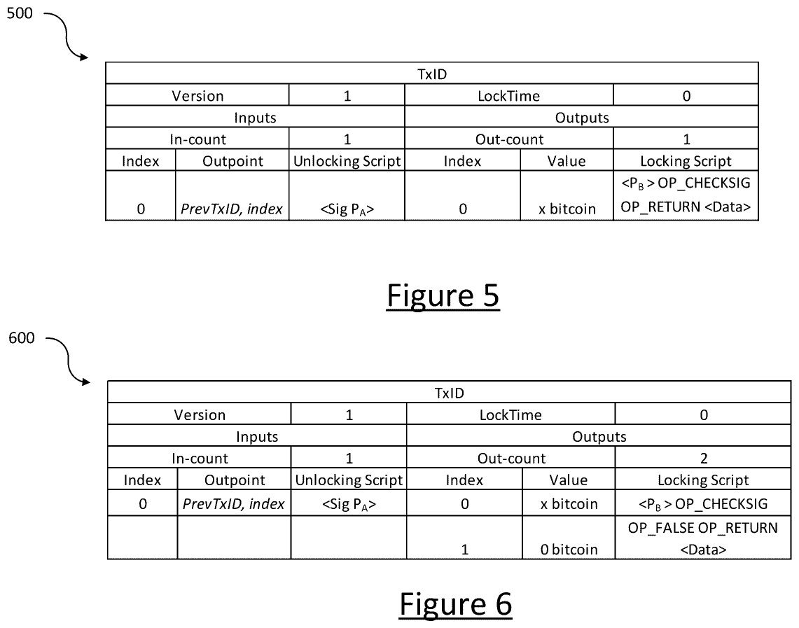

FIG. 5 illustrates an example transaction 500 comprising unwanted data (<Data>) present in a spendable output of the transaction 500.

As shown in FIG. 5, the unwanted data may be placed after the opcodes OP_CHECKSIG and OP_RETURN. In another example, the unwanted data may be placed after the opcodes OP_CHECKSIG and OP_PUSH and before the opcode OP_DROP (i.e. <P_{B}> OP_CHECKSIG OP_PUSH <Data> OP_ DROP). It will be appreciated that other methods may be employed by a malicious entity to place unwanted data in a locking script of a spendable output of a transaction.

In this example the validity of the UTXO has to be considered when it is spent in the future. Any new transaction must reference a UTXO. When the new transaction is validated it is necessary to know information about the UTXO such as bitcoin value and locking script. This presents an issue when a UTXO contains unwanted data and is spent by a new transaction. In order to validate the new transaction it is necessary to validate the UTXO, and therefore have knowledge of the unwanted data. If any other nodes or services providers need to validate this transaction, they must also have access to the unwanted data. The unwanted data may live in a UTXO set indefinitely because it is not known when a UTXO will be spent. The UTXO set may be open to the public through block explorers.

In an alternative example, the unwanted data can be present in any other part of the transaction (i.e. the unwanted data is not in a spendable output and so plays no further role in the consensus process). For example, the unwanted data may be present in an unspendable transaction output (typically characterised by an OP_FALSE OP_RETURN script pattern). This is illustrated in FIG. 6 which shows an example transaction 600 comprising unwanted data in an unspendable transaction output. In this case the unwanted data is not in a spendable output and so plays no further role in the consensus process.

As explained above, when the OP_RETURN opcode is preceded by OP_FALSE at the beginning of a locking script, this creates an unspendable output of a transaction that a malicious entity can utilise to store unwanted data within the transaction, and thereby record the data immutably in the blockchain 150.

In this alternative example, blockchain node 104 could simply refuse to share the part of the transaction containing the unwanted data. This is known as pruning and is mentioned in the Bitcoin white paper as a method for nodes to reclaim disk space. Since the unwanted data will not affect the validation of any new transactions it will not be needed in the future. The pruning method has a drawback that the integrity of any other fields in the transaction cannot be independently validated.

In FIG. 6, if unwanted data in the second output is removed, the first output may still be unspent. This is acceptable since removing data from the second output does not affect the validation of a transaction that spends the first output.

It will be appreciated that unwanted data can be present in both a spendable output and an unspendable output of the same transaction.

Embodiments of the present disclosure relate to a mechanism whereby unwanted data can be removed from a transaction by a blockchain node 104 whilst allowing the remaining fields to be validated for a given transaction ID and/or providing on-chain evidence of data removal in compliance with a data distribution control message.

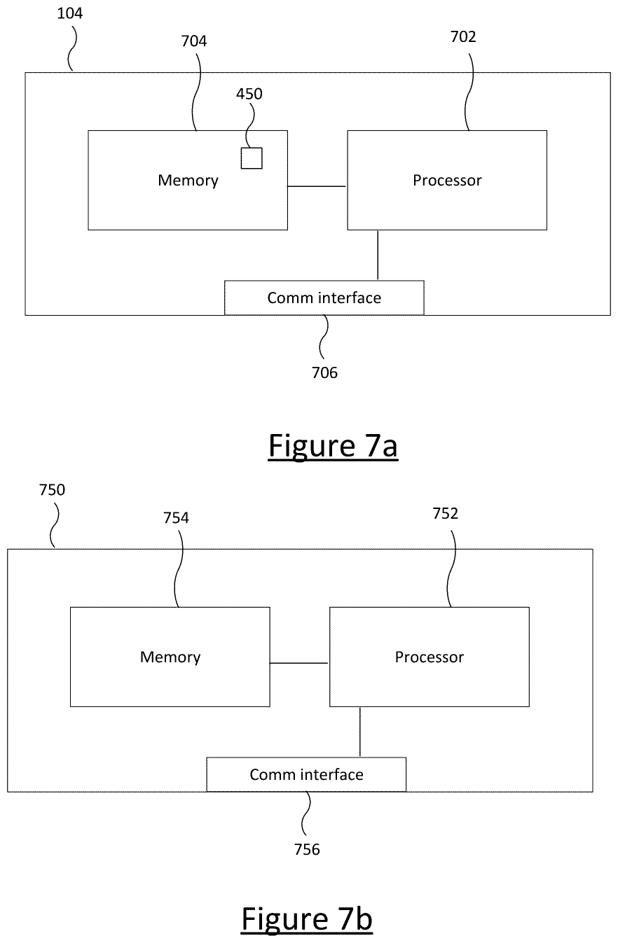

FIG. 7a illustrates a schematic block diagram of a blockchain node 104. The blockchain node 104 comprises processing apparatus 702 comprising one or more processors, e.g. one or more central processing units (CPUs), accelerator processors, application specific processors and/or field programmable gate arrays (FPGAs), and other equipment such as application specific integrated circuits (ASICs). The blockchain node 104 also comprises memory 704, i.e. computer-readable storage in the form of a non-transitory computer-readable medium or media. The memory 704 may comprise one or more memory units employing one or more memory media, e.g. a magnetic medium such as a hard disk; an electronic medium such as a solid-state drive (SSD), flash memory or EEPROM; and/or an optical medium such as an optical disk drive. The memory 704 may store node software 450. The memory 704 may store a respective copy of the blockchain 150. The functionality of the processor 702 described herein may be implemented in code (software) stored on a memory (e.g. memory 704). The code is configured so as when fetched from the memory and executed on the processor 702 to perform operations in line with embodiments discussed herein. The blockchain node 104 also comprises a communications interface to allow data to be transmitted to/from the blockchain node 104.

FIG. 7b illustrates a schematic block diagram of a data distribution control device 750. The data distribution control device 750 comprises processing apparatus 752 comprising one or more processors, e.g. one or more central processing units (CPUs), accelerator processors, application specific processors and/or field programmable gate arrays (FPGAs), and other equipment such as application specific integrated circuits (ASICs). The data distribution control device 750 also comprises memory 754, i.e. computer-readable storage in the form of a non-transitory computer-readable medium or media. The memory 754 may comprise one or more memory units employing one or more memory media, e.g. a magnetic medium such as a hard disk; an electronic medium such as a solid-state drive (SSD), flash memory or EEPROM; and/or an optical medium such as an optical disk drive. The functionality of the processor 752 described herein may be implemented in code (software) stored on a memory (e.g. memory 754). The code is configured so as when fetched from the memory and executed on the processor 752 to perform operations in line with embodiments discussed herein. The data distribution control device 750 also comprises a communications interface to allow data to be transmitted to/from the blockchain node 104.

The data distribution control device 750 is coupled to the packet-switched network 101. The data distribution control device 750 may be external to the blockchain network 106 but nevertheless be able to communicate with the blockchain nodes 104.

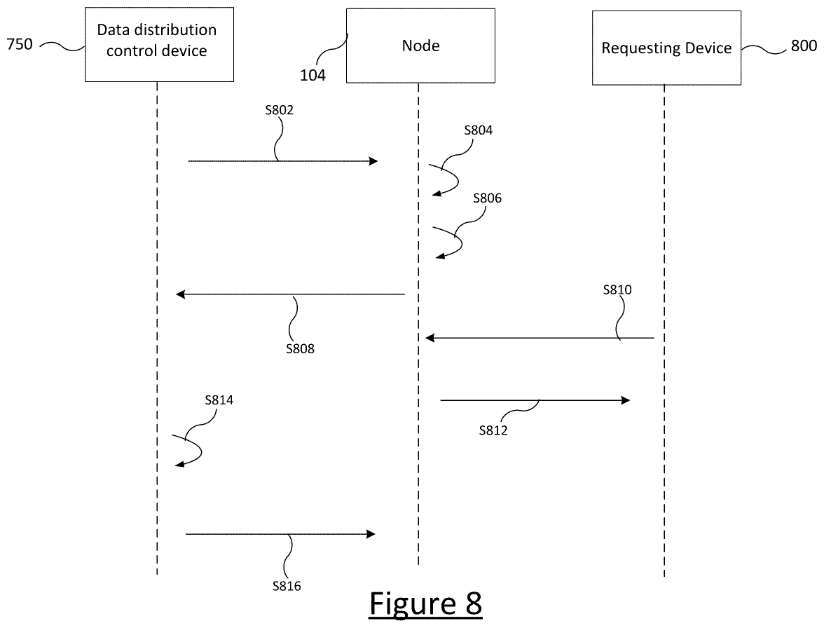

Embodiments of the present disclosure are now described with reference to a sequence diagram shown in FIG. 8.

At step S802, the blockchain node 104 receives a data distribution control message indicating that data of a transaction (Tx) stored in memory of the blockchain node 104 should not be distributed by the blockchain node 104 to anyone (not even other blockchain nodes). In particular, the data distribution control message specifies a particular transaction by way of one or more unique identifier (e.g. a transaction ID) associated with the transaction. The data distribution control message further specifies which data in the transaction is unwanted data by way of one or more identifiers of the unwanted data that is stored in the transaction. It will appreciated that this may be achieved in a number of different ways. For example, the data distribution control message may include an identifier (e.g. an index number) of a particular output of the transaction e.g. to indicate that all data in the second output of the transaction is unwanted data. Additionally or alternatively, the data distribution control message may include a one or more bit identifiers to identify locations of bits corresponding to the unwanted data in the transaction e.g. to indicate that data in bit positions 2000-3000 is unwanted data. The data distribution control message is transmitted from the data distribution control device 750 to the blockchain node 104.

In response to receipt of the data distribution control message, at step S804 the blockchain node 104 is configured to obtain a zero knowledge proof (ZKP) for proving removal of the unwanted data from the transaction.

In some implementations, the blockchain node 104 may obtain the ZKP by generating the ZKP itself. The ZKP may be generated using (i) the transaction referred to in the data distribution control message, (ii) the one or more identifiers of the unwanted data that is stored in the transaction, the one or more identifiers included in the data distribution control message; and (iii) a public parameter.

In other implementations, the blockchain node 104 does not perform the generation of the ZKP itself. Instead, the blockchain node 104 may receive the ZKP from a remote computing device.

The blockchain node 104 may receive the ZKP from a remote computing device in response to the blockchain node 104 transmitting (i) the transaction referred to in the data distribution control message, and (ii) the one or more identifiers of the unwanted data that is stored in the transaction; to the remote computing device. In these examples, the remote computing device may be external to the blockchain network 106. That is, the remote computing device may not be a blockchain node 104. Alternatively the remote computing device may be another blockchain node 104.

Whilst FIG. 8, shows a single blockchain node 104 for simplicity, the data distribution control device 750 may transmit the data distribution control message to a plurality of the blockchain nodes 104 in the blockchain network 106. Thus, the blockchain node 104 shown in FIG. 8 may receive the ZKP from another blockchain node that has also received the data distribution control message and has generated the ZKP in response thereto. It will be appreciated that in these examples it is not necessary for the blockchain node 104 shown in FIG. 8 to transmit (i) the transaction referred to in the data distribution control message, and (ii) the one or more identifiers of the unwanted data that is stored in the transaction; to the ZKP generating blockchain node.

It will be apparent that the ZKP can be constructed by a blockchain node, a blockchain service provider, or any other entity with access to the unwanted data. We refer herein to a blockchain service provider as an entity which serves blockchain data but does not produce blocks. For example, a blockchain service provider may be an entity providing a block explorer such as WhatsOnChain which serves blockchain data upon request. In another example, a blockchain service provider may be an entity providing a platform which receives data from a user, puts it in a transaction, pays the fee, sends the transaction to the blockchain network, and provides proof of inclusion of the data on the blockchain to the user.

Zero-Knowledge Proofs (ZKPs) are a method by which a party, known as the prover, may prove to another party, known as the verifier, that a statement is true, without revealing any information beside the fact that the statement is true. In embodiments of the present disclosure, a ZKP is generated to provide proof that unwanted data specified in a data distribution control message has been removed from a specific transaction (also specified in a data distribution control message). That is, the term ‘zero-knowledge proof’ is used herein to mean a proof of knowledge between a prover and a verifier for which no information about the unwanted data is revealed.

Embodiments of the present disclosure are not limited to any particular type of ZKP. The ZKP obtained at step S804 may be a type of interactive zero-knowledge proof (which require interaction between the prover and the verifier). Alternatively, the ZKP obtained at step S804 may be a type of Non-Interactive Zero-Knowledge (NIZK) proof where the prover produces just one message called a ‘proof’ to convince the verifier that the statement is true (i.e. unwanted data has been removed from the transaction).

A zkSNARK (Zero-Knowledge Succinct Non-Interactive Argument of Knowledge) is one example of a NIZK proof that is succinct and for which proofs are very short and easy to verify. The statement is represented in terms of an arithmetic circuit that is used to generate a proof of the statement.

In the example where the ZKP is a zkSNARK proof, the public parameter corresponds to a proving key (which is part of a prover and verification key pair computed during a setup phase).

As is known by persons skilled in the art, proving and verification keys work within the context of zkSNARKs but do not work with other types of zero knowledge proofs such as MPC based proofs (such as zkBOO), STARK, or Bulletproofs. However all types of zero knowledge proof use some public parameter to generate the proof, and the form that this public parameter takes is dependent on the type of zero knowledge proof employed.

In response to receipt of the data distribution control message, at step S806 the blockchain node 104 is configured to remove the unwanted data from the transaction (Tx) in compliance with the data distribution control message to generate a modified transaction (Tx′). The modified transaction (Tx′) corresponds to the original transaction (Tx) without the unwanted data. It will be appreciated that knowledge of the unwanted data is needed in order to generate the ZKP. The transaction ID of the transaction (Tx) is not modified. That is, the transaction ID of the transaction (Tx) is the same as the modified transaction (Tx′). The ZKP is used to relate the incomplete transaction data in the modified transaction (Tx′) to the transaction ID. In particular, the ZKP contains the transaction ID as a fixed public parameter, so the transaction ID can be considered as data that is included explicitly as part of the ZKP. When a verifier verifies the ZKP, a verification process takes the ZKP and the modified transaction (Tx′) as inputs (and also a verification key in the context of zkSNARKs) and outputs a ‘true’ or ‘false’ decision (e.g. a bit 1 or 0). If the correct redacted transaction for a given TxID is given as an input to the ZKP then the output will be ‘true’.

The ZKP provides proof that only the unwanted data has been removed from the transaction, and that the blockchain node has not removed or tampered with the transaction in any other way. In particular, the ZKP provides proof that the unwanted data has been “soundly removed” from a given transaction i.e. if a transaction comprises data {X∥Y}, and Y is soundly removed then what is left is {X∥.} . This means that X has not been tampered with. If Y had not been soundly removed then what is left may be {Z∥.} , which is not consistent with the starting data.

It is important that the data associated with bitcoin value and public keys are not removed from the transaction as they can help identify who uploaded the unwanted data and what bitcoin has been used for that purpose. This can also aid the recovery of the bitcoin in a transparent manner.

This is particularly when the unwanted data is present in a UTXO and so many different entities may be interested in the data. For example, the sender or receiver of a transaction spending the UTXO containing the data, and any nodes or blockchain service providers who are involved in the processing of this transaction. Any one of these entities may wish to prove to another entity that they have complied with the data distribution control message. A blockchain node or blockchain service provider may wish to prove to that they have deleted a specific part of a transaction even if it is not in a UTXO.

In some implementations, the blockchain node 104 still retains the unwanted data in memory 704 after removal of the unwanted data from the transaction. In other implementations, the blockchain node 104 does not retain the unwanted data in memory 704 after removal of the unwanted data from the transaction.

At step S808, the blockchain node 104 is configured to transmit the ZKP to the data distribution control device 750. The ZKP provides evidence to the data distribution control device 750 that the blockchain node 104 has complied with the data distribution control message. The data distribution control device 750 receives the ZKP transmitted from the blockchain node 104.

By validating the ZKP, the data distribution control device 750 can explicitly check that the proof relates to the correct part of the transaction identified in the data distribution control message. Techniques to validate a ZKP (which give a VALID or NON-VALID output) are known to persons skilled in the art and are not discussed in detail herein. As a mere example, if the ZKP is a zkSNARK, then the data distribution control device 750 (or any other verifier) needs: a verification key (corresponding to the proving key described above), all data of the transaction (which held the unwanted data) other than the unwanted data itself, and the ZKP.

At step S810, the blockchain node 104 may receive a request for the transaction (Tx) identified in the data distribution control message. The request is transmitted from a requesting computing device 800. The requesting computing device 800 may for example be a user's computer equipment 102. Alternatively, the requesting computing device 800 may be a blockchain node 104, for example when a new miner enters the blockchain network, they must download the entire blockchain and validate every transaction to construct the UTXO set. The request received at step S810 may be transmitted from the requesting computing device 800 as part of the process to download the entire blockchain and validate every transaction to construct the UTXO set.

In response to receipt of the request received at step S810, at step S812 the blockchain node 104 transmits the modified transaction (Tx′) and the ZKP to the requesting computing device 800. The modified transaction (Tx′) does not comprise the unwanted data so the transmission at step S812 is in compliance with the data distribution control message. The ZKP used in embodiments of the present disclosure proves that a redacted transaction data is correct for a given transaction ID. In particular, the ZKP transmitted at step S812 proves to the requesting computing device 800 that the redacted transaction data in the modified transaction (Tx′) is correct for the transaction ID of the modified transaction (Tx′). The ZKP allows the non-unwanted data (the remaining data in the modified transaction following step S806) to be validated thus providing transparency and auditability. This is particularly useful when the unwanted data is in a UTXO as there may be many parties that are affected by the data distribution control message.

At step S812 the blockchain node 104 may additionally transmit the data distribution control message to the requesting computing device 800.

Once the blockchain node 104 has obtained the ZKP at step S804, the blockchain node 104 may transmit the ZKP to one or more other blockchain nodes 104 in the blockchain network 106. Since the ZKP does not require any trust in the creator of the ZKP, once it has been created it may be re-used by any other device, such as other node blockchain nodes 104 in the blockchain network 106. This advantageously minimises processing overhead in the blockchain network, as it is not necessary for each blockchain node 104 in the blockchain network 106 to generate a ZKP which can be computationally expensive.

Whilst we have referred above to a simple example whereby the data distribution control message identifies a single transaction storing unwanted data, it will be appreciated that the data distribution control message may identify that unwanted data of multiple transactions stored in memory of the blockchain node 104 should not be distributed by the blockchain node 104. In these examples the blockchain node 104 performs step S804, S806, and S808 for each transaction identified in the data distribution control message. That is, a ZKP is obtained for each transaction stored by the blockchain node 104 which comprises unwanted data and is identified in the data distribution control message. Each ZKP is constructed for a specific transaction ID, TxID, which is data explicitly recorded as part of the respective ZKP.

In response to receiving the ZKP at step S808, if the unwanted data was present in a spendable output of a transaction, the data distribution control device 750 may be configured to generate a recordal transaction at step S814 to provide evidence of removal of the data from the transaction in compliance with the data distribution control message.

The evidence may comprise the ZKP or a commitment of the ZKP. The commitment of the ZKP may for example be a hash of the ZKP, or a Pedersen commitment. Additionally or alternatively, the evidence may comprise the data distribution control message or a commitment of the data distribution control message. The commitment of the data distribution control message may for example be a hash of the data distribution control message, or a Pedersen commitment. The evidence may also comprise metadata associated with the removal of the data from the transaction. We refer herein to examples of commitments that may be used in embodiments of the present disclosure such as a hash or a Pedersen commitment. It will be appreciated that these are examples, and the evidence of removal of the data may comprise other types of commitment.

At least a portion of the evidence may be stored in an input of the recordal transaction. In particular, one or more of: (i) the ZKP or a commitment of the ZKP; (ii) the data distribution control message or a commitment of the data distribution control message; and (iii) the metadata; may be stored in an input of the recordal transaction.

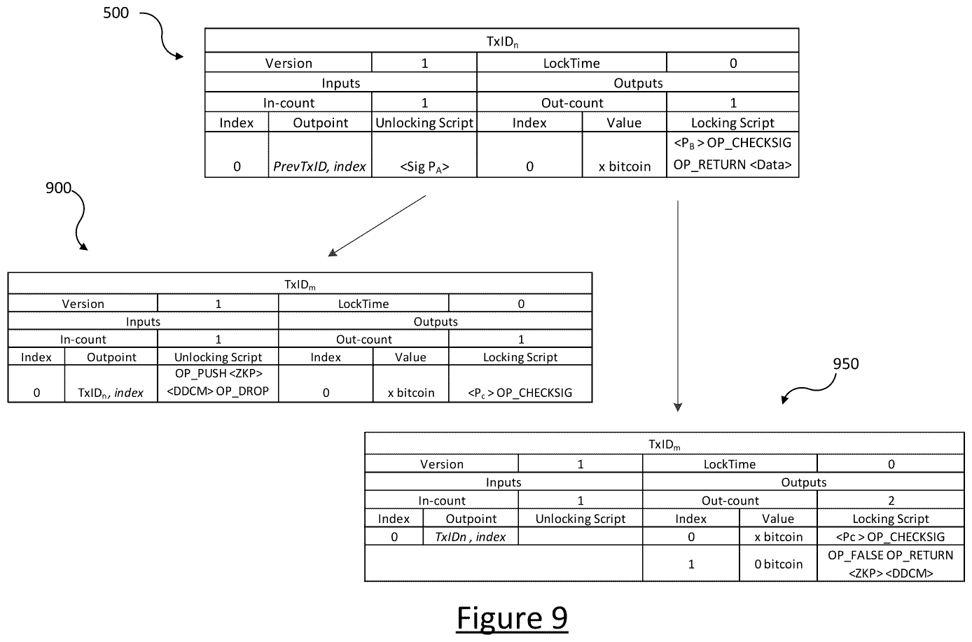

FIG. 9 illustrates an example recordal transaction 900 whereby both the ZKP and the data distribution control message are provided in an input of the recordal transaction 950 having a transaction ID of TXIDₘ.

The input of the example recordal transaction 900 identified by Index 0 comprises a pointer pointing back to the transaction 500 (e.g. by means of its transaction ID, TxIDₙ, which in embodiments is the hash of the whole transaction 500). The input of the example recordal transaction 900 also comprises an index identifying UTXO0 (which stored the unwanted data prior to removal) within the transaction 500, to identify it amongst any other possible outputs of the transaction 500. As shown in FIG. 9, the input of the example recordal transaction 900 identified by index 0 also comprises both the ZKP and the data distribution control message in an unlocking script (this implicitly links the evidence of removal of the unwanted data from the transaction 500 with UTXO₀ of the transaction 500 (which stored the unwanted data prior to removal). These can be included in the unlocking script as items that are pushed and then dropped from the stack, i.e. OP_PUSH <ZKP> OP_DROP, and so do not affect the execution of the script.

Whilst the example recordal transaction 900 shows both the ZKP and the data distribution control message in an unlocking script, when they are both present there is no requirement for them to be co-located within the recordal transaction 900, and as explained above, the recordal transaction 900 may not comprise both the ZKP and the data distribution control message.

At least a portion of the evidence may be stored in an output of the recordal transaction. That is, one or more of: (i) the ZKP or a commitment of the ZKP; (ii) the data distribution control message or a commitment of the data distribution control message; and (iii) the metadata; may be stored in an output of the recordal transaction. The output storing a portion of the evidence may be a spendable output or an unspendable output.

FIG. 9 further illustrates an example recordal transaction 950 whereby both the ZKP and the data distribution control message are provided in an unspendable output of the recordal transaction 950 having a transaction ID of TXIDₘ.

The input of the example recordal transaction 950 identified by Index 0 comprises a pointer pointing back to the transaction 500 (e.g. by means of its transaction ID, TxIDₙ), which in embodiments is the hash of the whole transaction 500). The input of the example recordal transaction 950 also comprises an index identifying UTXO0 (which stored the unwanted data prior to removal) within the transaction 500, to identify it amongst any other possible outputs of the transaction 500.

As shown in FIG. 9, the recordal transaction 950 comprises both the ZKP and the data distribution control message in a locking script of an unspendable output. However, as noted above, at least a portion of the evidence may be stored in a spendable output of the recordal transaction (e.g. <P_{C}> OP_CHECKSIG OP_RETURN <ZKP> <DDCM>).

When the evidence (e.g. the ZKP and/or the data distribution control message) of removal of the unwanted data from the transaction 500 is provided in an output of the recordal transaction 950, the recordal transaction 950 links the evidence to the particular UTXO which stored the unwanted data prior to removal (e.g. UTXO0 of the transaction 500).

One way of providing this link is to include the transaction ID of transaction 500 (TxIDn) and an output index number in the output of the recordal transaction 950 (e.g. in the OP_RETURN data), the combination of the TxIDn and the output index number thereby specifying the UTXO which stored the unwanted data prior to removal. In the example of FIG. 9, the output index number (index 0) is used to identify UTXO0 (which stored the unwanted data prior to removal) within the transaction 500.

When the ZKP is provided in the output of the recordal transaction 950, the ZKP will explicitly mention the transaction ID of transaction 500 (TxIDn) as the ZKP was generated from the transaction 500. In particular, the ZKP contains TxIDn as a fixed public parameter (and therefore TxIDn can be considered as being included as part of the ZKP). In these examples, it is not necessary to explicitly specify TxIDn in the output of the recordal transaction 950 (e.g. in the OP_RETURN data) in addition to the ZKP. In these examples an output index number may also be provided in the output of the recordal transaction 950 (e.g. in the OP_RETURN data), the combination of the TxIDn and the output index number thereby specify the UTXO. In the example of FIG. 9, the output index number is used to identify UTXO0 (which stored the unwanted data prior to removal) within the transaction 500.

When the data distribution control message is provided in the output of the recordal transaction 950, the data distribution control message may specify the particular UTXO storing the unwanted data to be redacted to thereby provide this link.

Whilst the example recordal transaction 950 shows both the ZKP and the data distribution control message in a locking script, when they are both present there is no requirement for them to be co-located within the recordal transaction 950, and as explained above, the recordal transaction 900 may not comprise both the ZKP and the data distribution control message.

The metadata referred to above may include one or any combination of: (i) a version number associated with the code (software) stored on in memory 754 that when fetched executed on the processor 752 performs operations in line with embodiments discussed herein; (ii) the type/scheme of zero knowledge proof associated with the ZKP received at step S808; (iii) data indicating that the ZKP or a commitment of the ZKP is included in the recordal transaction; (iv) an identifier of a location of the ZKP or a commitment of the ZKP in the recordal transaction (v) data indicating that the data distribution control message or a commitment of the data distribution control message is included in the recordal transaction; (vi) an identifier of a location of the data distribution control message or a commitment of the data distribution control message in the recordal transaction; a date and/or time that the recordal transaction was generated.

In the example illustrated, UTXO0 in the output of transaction 500 comprises a locking script which requires a signature P_{B} of Bob in order for UTXO0 to be redeemed (strictly, in order for a subsequent transaction attempting to redeem UTXO0 to be valid).

The input of the recordal transaction 900,950 would typically comprise an unlocking script which comprises a cryptographic signature of Bob, created by Bob applying his private key to a predefined portion of data (sometimes called the “message” in cryptography). The data (or “message”) that needs to be signed by Bob to provide a valid signature may be defined by the locking script, or by the node protocol, or by a combination of these. This message comprises UTXO0 in the output of transaction 500 i.e. it includes the unwanted data. In one example, this messages comprises UTXO0 of transaction 500 (e.g. value assigned to the first output and the first locking script of the first output) and all contents of the recordal transaction 900,950 except all unlocking scripts of the recordal transaction.

In some embodiments of the present disclosure, the recordal transaction 900,950 does not include a signature predicated by the UTXO locking script of the transaction 500. In particular, the recordal transaction 900,950 does not include a signature of a message comprising the spendable output of the transaction 500 which comprises the unwanted data. Thus, a party does not need to know the unwanted data in transaction 500 order to validate the recordal transaction 900,950.

If the spendable output of the transaction 500 comprising the unwanted data assigns a value of a digital asset to an entity, the recordal transaction may comprises a spendable output which reassigns the value of the digital asset to a different entity. This is illustrated in FIG. 9 whereby the value of x bitcoin is reassigned in the example recordal transactions 900,950 by including the public key Pc (which could be associated with some entity of authority) in a locking script corresponding to the value of x bitcoin.

Once the recordal transaction has been generated at step S814, at step S816 the data distribution control device 750 transmits the recordal transaction to the blockchain node 104 for commital onto the blockchain.

Whilst the sequence diagram of FIG. 8 shows steps being performed in a specific order, embodiments of the present disclosure are not limited to the steps of FIG. 8 being performed in this specific order. For example, step S814 may be performed before step S810, or steps S814 and S816 may be performed before steps S810 and S812.

Whilst we have referred above to a simple example whereby the data distribution control message identifies a single transaction storing unwanted data, a single ZKP is received by the data distribution control device 750, and a single recordal transaction is generated by the data distribution control device 750, this is merely an example. In embodiments, whereby the data distribution control message identifies multiple transactions storing unwanted data, and the data distribution control device 750 receives multiple ZKPs, one or more recordal transactions may be generated at step S814 to provide evidence of removal of the data from the transaction in compliance with the data distribution control message. For example, a single recordal transaction may be generated (e.g. referencing multiple ZKPs) to provide evidence of removal of the data from the multiple transactions in compliance with the data distribution control message. In another example, a plurality of recordal transactions may be generated at step S814, each of the plurality of recordal transactions providing evidence of removal of the data from a respective transaction of the multiple transactions in compliance with the data distribution control message.

Whilst we have described steps S814 and S816 being performed by the data distribution control device 750, S814 and S816 may be performed by the blockchain node 104. In particular, once the blockchain node 104 has generated the recordal transaction at S814 it may add the recordal transaction to its mempool and transmit the recordal transaction to one or more other blockchain nodes 104 in the blockchain network 106.

The recordal transaction (for example comprising the ZKP) is then included on the blockchain to provide on-chain evidence of removal of the data from the transaction in compliance with the data distribution control message. Thus in embodiments of the present disclosure, unwanted data can be removed from transactions, but an evidence trail is always present (this is the immutability of a blockchain). The ZKP provides greater granularity over exactly which bits of data have been removed.

The advantages of using a ZKP is that it provides an independent mathematical proof of a statement. In embodiments of the present disclosure, the ZKP ensure that it can be proved that a piece of data has been removed without having to trust a blockchain node or service provider.

In one example, a data distribution control message may indicate that there is a piece of illegal data in the first output of a transaction Tx. Suppose this first output is spendable and has not yet been spent (a UTXO). In accordance with embodiments of the present disclosure, the data distribution control message alerts the blockchain nodes to the piece of illegal data. One of the blockchain nodes removes the data, and creates a ZKP to prove that they have removed this data. They share the ZKP with the data distribution control device and with the other blockchain nodes. Because the ZKP allows other fields in the transaction to be validated, the blockchain nodes can prove that a signature related to public key P was used to upload the illegal data. At a later date, an individual may identified using the public key P. The ZKP can be used to prove that their public key was associated with the illegal data, and the individual may be prosecuted.

In another example, the data distribution control device issues a data distribution control message stating that there is illegal data in an unspendable output of transaction that has appeared many blocks deep in a blockchain. A blockchain node complies with this data distribution control message by creating a ZKP to prove that either the illegal data or the entire unspendable output has been removed of the pruned transaction, and prunes the output containing the illegal data. The blockchain node stores the ZKP either in its own internal log file in memory and/or on the blockchain as proof of pruning. The blockchain node no longer distributes the output containing the illegal data, but if any other device requests the transaction without the output then the blockchain node can share it with them along with the ZKP.

### Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

According to one aspect disclosed herein, there is provided a method performed by a computing device, the method comprising: transmitting a data distribution control message to a node of a blockchain network, the data distribution control message indicating that data in a transaction of a plurality of transactions, stored by the node and associated with a blockchain, should not be distributed by the node; receiving, from the node, a zero knowledge proof proving removal of the data from the transaction in compliance with the data distribution control message; generating a recordal transaction, the recordal transaction comprising evidence of removal of the data from the transaction in compliance with the data distribution control message; and transmitting the recordal transaction to the node for committal to the blockchain.

The data distribution control message may indicate that it is the data in a spendable output of the transaction that should not be distributed.

The evidence may comprises the zero knowledge proof or a commitment of the zero knowledge proof.

The evidence may comprises the data distribution control message or a commitment of the data distribution control message.

At least a portion of the evidence may be stored in an output of the recordal transaction.

The output may be a spendable output of the recordal transaction. Alternatively, the output may be an unspendable output of the recordal transaction.

At least a portion of the evidence may be stored in an input of the recordal transaction.

The recordal transaction may comprise metadata associated with the removal of the data from the transaction.

The recordal transaction may not include a signature of data comprising the spendable output of the transaction.

A spendable output of the transaction may assign a value of a digital asset to an entity, and the recordal transaction may comprise a spendable output which reassigns the value of the digital asset to a different entity.

The data distribution control message may indicate that data in a multiple transactions of the plurality of transactions should not be distributed by the node.

The method may comprise: receiving, from the node, a plurality of zero knowledge proofs, each zero knowledge proof of the plurality of zero knowledge proofs proving removal of the data from a respective transaction of the multiple transactions in compliance with the data distribution control message; generating one or more recordal transactions to provide evidence of removal of the data from the multiple transactions in compliance with the data distribution control message; and transmitting the one or more recordal transactions to the node for committal to the blockchain.

The computing device may be external to the blockchain network.

The zero knowledge proof may be a zkSNARK (Zero-Knowledge Succinct Non-Interactive Argument of Knowledge) proof.

According to another aspect disclosed herein, there is provided a computer-readable medium storing processor-executable instructions, the processor-executable instructions including instructions that, when executed by one or more processors, cause the one or more processors to carry out any of the methods described herein. The computer-readable medium may be a non-transitory medium.

According to another aspect disclosed herein, there is provided a computing device, the computing device including: one or more processors; memory; and computer-executable instructions stored in the memory that, when executed by the one or more processors, cause the processors to carry any of the methods described herein.

1. A method performed by a computing device, the method comprising:
transmitting a data distribution control message to a node of a blockchain network, the data distribution control message indicating that data in a transaction of a plurality of transactions, stored by the node and associated with a blockchain, should not be distributed by the node;
receiving, from the node, a zero knowledge proof proving removal of the data from the transaction in compliance with the data distribution control message;
generating a recordal transaction, the recordal transaction comprising evidence of removal of the data from the transaction in compliance with the data distribution control message; and
transmitting the recordal transaction to the node for committal to the blockchain.

2. The method of claim 1, wherein the evidence comprises the zero knowledge proof.

3. The method of claim 1, wherein the evidence comprises a commitment of the zero knowledge proof.

4. The method of claim 1, wherein the evidence comprises the data distribution control message.

5. The method of claim 1, wherein the evidence comprises a commitment of the data distribution control message.

6. The method of claim 1, wherein at least a portion of the evidence is stored in an output of the recordal transaction.

7. The method of claim 6, wherein the output is a spendable output of the recordal transaction.

8. The method of claim 6, wherein the output is an unspendable output of the recordal transaction.

9. The method of claim 1, wherein at least a portion of the evidence is stored in an input of the recordal transaction.

10. The method of claim 1, wherein the recordal transaction comprises metadata associated with the removal of the data from the transaction.

11. The method of claim 1, wherein the recordal transaction does not include a signature of data comprising a spendable output of the transaction.

12. The method of claim 1, wherein a spendable output of the transaction assigns a value of a digital asset to an entity, and the recordal transaction comprises a spendable output which reassigns the value of the digital asset to a different entity.

13. The method of claim 1, wherein the data distribution control message indicates that data in multiple transactions of the plurality of transactions should not be distributed by the node.

14. The method of claim 13, wherein the method comprises:
receiving, from the node, a plurality of zero knowledge proofs, each zero knowledge proof of the plurality of zero knowledge proofs proving removal of the data from a respective transaction of the multiple transactions in compliance with the data distribution control message;
generating one or more recordal transactions to provide evidence of removal of the data from the multiple transactions in compliance with the data distribution control message; and
transmitting the one or more recordal transactions to the node for committal to the blockchain.

15. The method of claim 1, wherein the computing device is external to the blockchain network.

16. The method of claim 1, wherein the zero knowledge proof is a zkSNARK (Zero-Knowledge Succinct Non-Interactive Argument of Knowledge) proof.

17. The method of claim 1, wherein the zero knowledge proof provides proof that only the indicated data has been removed from the transaction, and that the node has not removed or modified any other data of the transaction.

18. A non-transitory computer-readable medium storing processor-executable instructions, the processor-executable instructions including instructions that, when executed by one or more processors, cause the one or more processors to perform a method comprising:
transmitting a data distribution control message to a node of a blockchain network, the data distribution control message indicating that data in a transaction of a plurality of transactions, stored by the node and associated with a blockchain, should not be distributed by the node;
receiving. from the node, a zero knowledge proof proving removal of the data from the transaction in compliance with the data distribution control message;
generating a recordal transaction, the recordal transaction comprising evidence of removal of the data from the transaction in compliance with the data distribution control message; and
transmitting the recordal transaction to the node for committal to the blockchain.

19. computing device, the computing device including:
one or more processors;
memory storing computer-executable instructions that, when executed by the one or more processors, cause the processors to perform a method comprising:
transmitting a data distribution control message to a node of a blockchain network, the data distribution control message indicating that data in a transaction of a plurality of transactions, stored by the node and associated with a blockchain, should not be distributed by the node;
receiving, from the node, a zero knowledge proof proving removal of the data from the transaction in compliance with the data distribution control message;
generating a recordal transaction, the recordal transaction comprising evidence of removal of the data from the transaction in compliance with the data distribution control message; and transmitting the recordal transaction to the node for committal to the blockchain.
